(19) United States
(12) Patent Application Publication
(10) Pub. No.: US 2024/0057096 A1
(43) Pub. Date: Feb. 15, 2024

(54) TECHNIQUES FOR COMMUNICATING MULTI-CELL DOWNLINK CONTROL INFORMATION

(71) Applicant: QUALCOMM Incorporated, San Diego, CA (US)

(72) Inventors: Kazuki TAKEDA, Tokyo (JP); Peter GAAL, San Diego, CA (US); Mostafa KHOSHNEVISAN, San Diego, CA (US); Wanshi CHEN, San Diego, CA (US); Jae Ho RYU, San Diego, CA (US)

(21) Appl. No.: 17/885,232

(22) Filed: Aug. 10, 2022

(51) Int. Cl. H04W 72/12; H04L 1/00

(52) U.S. Cl. CPC H04W 72/1289; H04W 72/1263; H04L 1/0004

(57) ABSTRACT

Various aspects of the present disclosure generally relate to wireless communication. In some aspects, a user equipment (UE) may receive, from a network node, a multi-cell downlink control information (MC-DCI) that indicates scheduling information for co-scheduled component carriers (CCs), wherein the MC-DCI indicates one or more of an antenna port(s) field or a modulation and coding scheme (MCS) field to be commonly applied to one or more of the co-scheduled CCs. The UE may perform a transmission based at least in part on the scheduling information indicated by the MC-DCI. Numerous other aspects are described.

### FIELD OF THE DISCLOSURE

Aspects of the present disclosure generally relate to wireless communication and to techniques and apparatuses for communicating multi-cell downlink control information (MC-DCI).

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

In some implementations, a method of wireless communication performed by a user equipment (UE) includes receiving, from a network node, a multi-cell downlink control information (MC-DCI) that indicates scheduling information for co-scheduled component carriers (CCs), wherein the MC-DCI indicates one or more of an antenna port(s) field or a modulation and coding scheme (MCS) field to be commonly applied to one or more of the co-scheduled CCs; and performing a transmission based at least in part on the scheduling information indicated by the MC-DCI.

In some implementations, a method of wireless communication performed by a network node includes transmitting, to a UE, an MC-DCI that indicates scheduling information for co-scheduled CCs, wherein the MC-DCI indicates one or more of an antenna port(s) field or an MCS field to be commonly applied to one or more of the co-scheduled CCs; and performing a transmission based at least in part on the scheduling information indicated by the MC-DCI.

In some implementations, an apparatus for wireless communication at a UE includes a memory and one or more processors, coupled to the memory, configured to: receive, from a network node, an MC-DCI that indicates scheduling information for co-scheduled CCs, wherein the MC-DCI indicates one or more of an antenna port(s) field or an MCS field to be commonly applied to one or more of the co-scheduled CCs; and perform a transmission based at least in part on the scheduling information indicated by the MC-DCI.

In some implementations, an apparatus for wireless communication at a network node includes a memory and one or more processors, coupled to the memory, configured to: transmit, to a UE, an MC-DCI that indicates scheduling information for co-scheduled CCs, wherein the MC-DCI indicates one or more of an antenna port(s) field or an MCS field to be commonly applied to one or more of the co-scheduled CCs; and perform a transmission based at least in part on the scheduling information indicated by the MC-DCI.

In some implementations, a non-transitory computer-readable medium storing a set of instructions for wireless communication includes one or more instructions that, when executed by one or more processors of a UE, cause the UE to: receive, from a network node, an MC-DCI that indicates scheduling information for co-scheduled CCs, wherein the MC-DCI indicates one or more of an antenna port(s) field or an MCS field to be commonly applied to one or more of the co-scheduled CCs; and perform a transmission based at least in part on the scheduling information indicated by the MC-DCI.

In some implementations, a non-transitory computer-readable medium storing a set of instructions for wireless communication includes one or more instructions that, when executed by one or more processors of a network node, cause the network node to: transmit, to a UE, an MC-DCI that indicates scheduling information for co-scheduled CCs, wherein the MC-DCI indicates one or more of an antenna port(s) field or an MCS field to be commonly applied to one or more of the co-scheduled CCs; and perform a transmission based at least in part on the scheduling information indicated by the MC-DCI.

In some implementations, an apparatus for wireless communication includes means for receiving, from a network node, an MC-DCI that indicates scheduling information for co-scheduled CCs, wherein the MC-DCI indicates one or more of an antenna port(s) field or an MCS field to be commonly applied to one or more of the co-scheduled CCs; and means for performing a transmission based at least in part on the scheduling information indicated by the MC-DCI.

In some implementations, an apparatus for wireless communication includes means for transmitting, to a UE, an MC-DCI that indicates scheduling information for co-scheduled CCs, wherein the MC-DCI indicates one or more of an antenna port(s) field or an MCS field to be commonly applied to one or more of the co-scheduled CCs; and means for performing a transmission based at least in part on the scheduling information indicated by the MC-DCI.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of a disaggregated base station architecture, in accordance with the present disclosure.

FIG. 4 is a diagram illustrating an example of a plurality of lookup tables and corresponding radio resource control (RRC) configurable parameters, in accordance with the present disclosure.

FIG. 5 is a diagram illustrating an example of a plurality of lookup tables and corresponding conditions, in accordance with the present disclosure.

FIGS. 6-13 are diagrams illustrating examples associated with communicating MC-DCI, in accordance with the present disclosure.

FIGS. 14-15 are diagrams illustrating example processes associated with communicating MC-DCI, in accordance with the present disclosure.

FIGS. 16-17 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

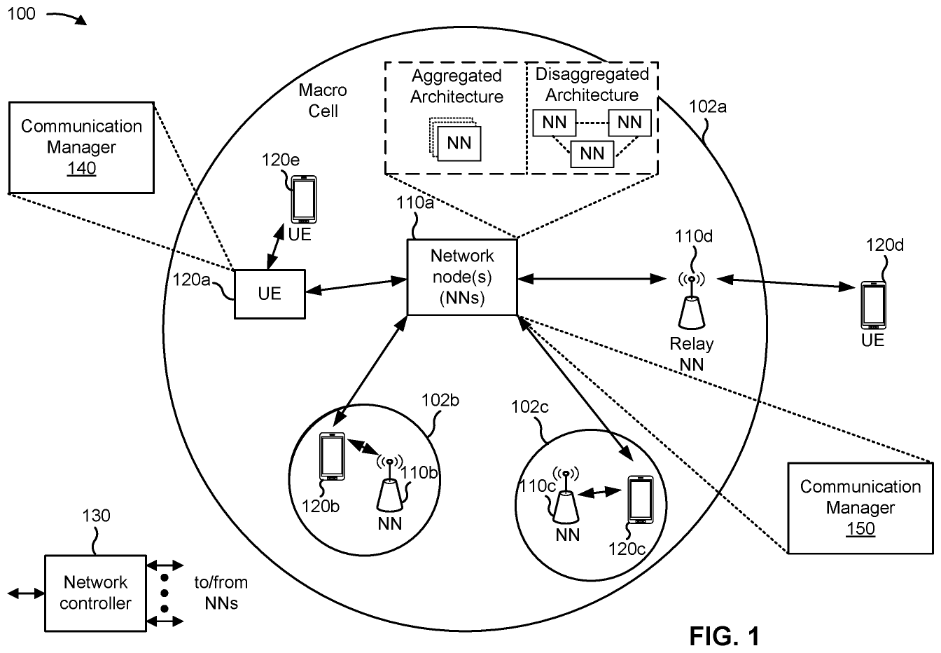

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, a UE (e.g., the UE 120) may include a communication manager 140. As described in more detail elsewhere herein, the communication manager 140 may receive, from a network node, a multi-cell downlink control information (MC-DCI) that indicates scheduling information for co-scheduled component carriers (CCs), wherein the MC-DCI indicates one or more of an antenna port(s) field or a modulation and coding scheme (MCS) field to be commonly applied to one or more of the co-scheduled CCs; and perform a transmission based at least in part on the scheduling information indicated by the MC-DCI. Additionally, or alternatively, the communication manager 140 may perform one or more other operations described herein.

In some aspects, a network node (e.g., the network node 110) may include a communication manager 150. As described in more detail elsewhere herein, the communication manager 150 may transmit, to a UE, an MC-DCI that indicates scheduling information for co-scheduled CCs, wherein the MC-DCI indicates one or more of an antenna port(s) field or an MCS field to be commonly applied to one or more of the co-scheduled CCs; and perform a transmission based at least in part on the scheduling information indicated by the MC-DCI. Additionally, or alternatively, the communication manager 150 may perform one or more other operations described herein.

As indicated above, FIG. 1 is provided as an example. Other examples may differ from what is described with regard to FIG. 1.

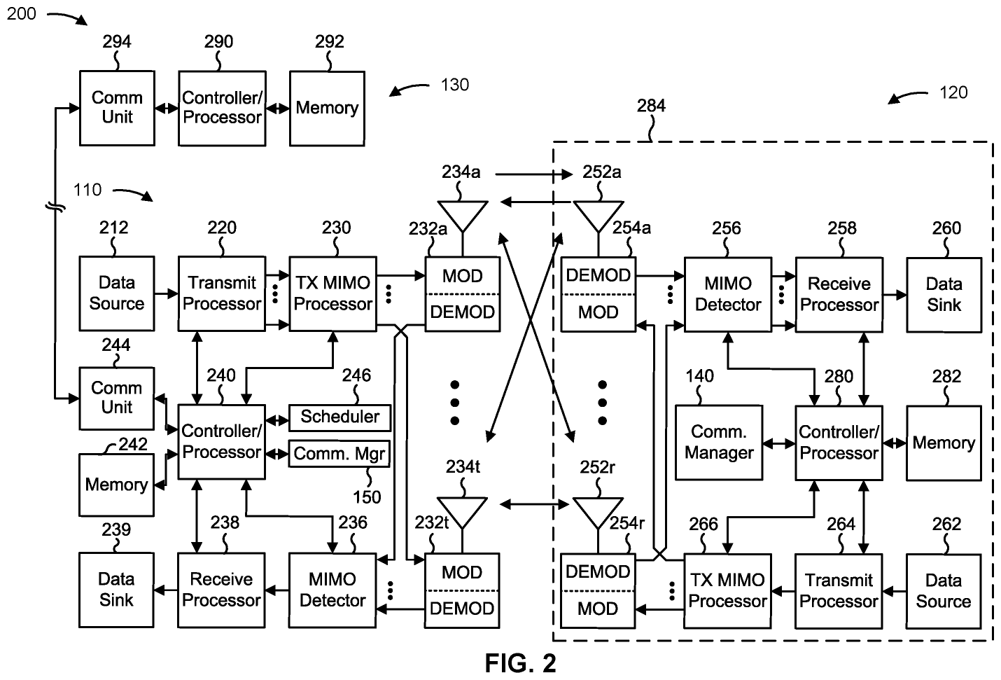

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MC S(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

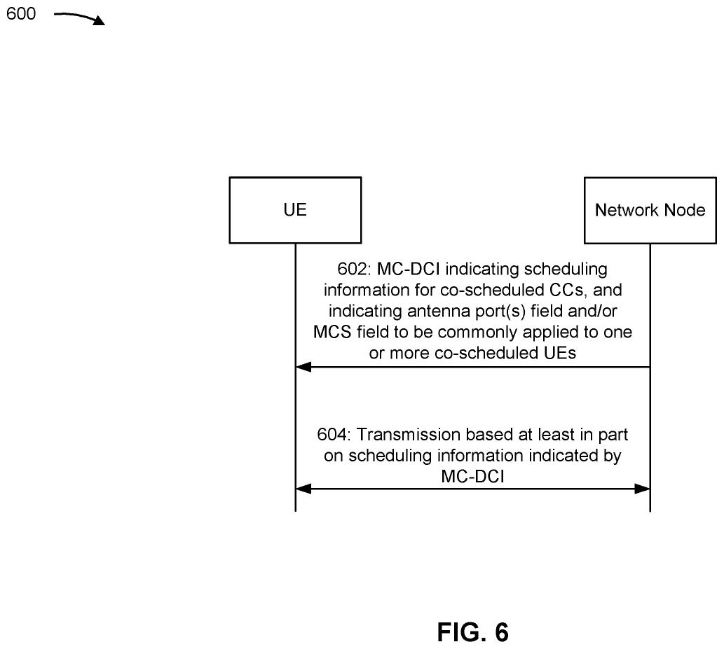

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 6-17).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 6-17).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

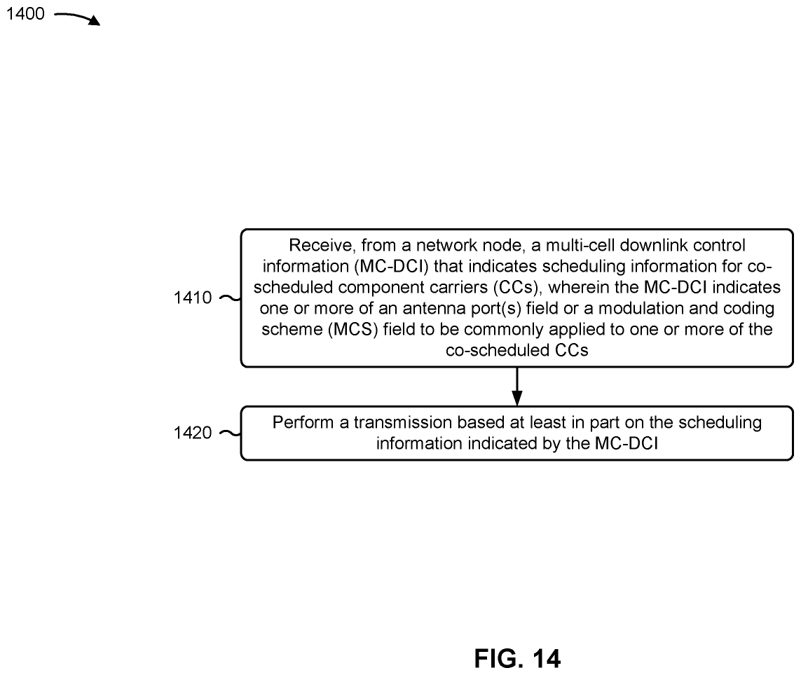

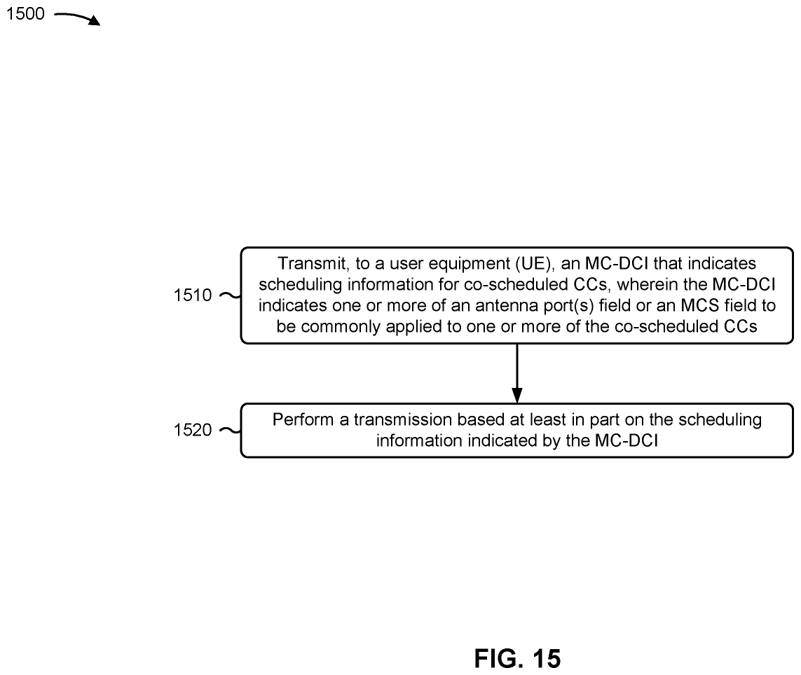

The controller/processor 240 of the network node 110, the controller/processor 280 of the UE 120, or any other component(s) of FIG. 2 may perform one or more techniques associated with communicating MC-DCI, as described in more detail elsewhere herein. For example, the controller/processor 240 of the network node 110, the controller/processor 280 of the UE 120, or any other component(s) (or combinations of components) of FIG. 2 may perform or direct operations of, for example, process 1400 of FIG. 14, process 1500 of FIG. 15, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 1400 of FIG. 14, process 1500 of FIG. 15, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving, from a network node, an MC-DCI that indicates scheduling information for co-scheduled CCs, wherein the MC-DCI indicates one or more of an antenna port(s) field or an MCS field to be commonly applied to one or more of the co-scheduled CCs; and/or means for performing a transmission based at least in part on the scheduling information indicated by the MC-DCI. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting, to a UE, an MC-DCI that indicates scheduling information for co-scheduled CCs, wherein the MC-DCI indicates one or more of an antenna port(s) field or an MCS field to be commonly applied to one or more of the co-scheduled CCs; and/or means for performing a transmission based at least in part on the scheduling information indicated by the MC-DCI. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

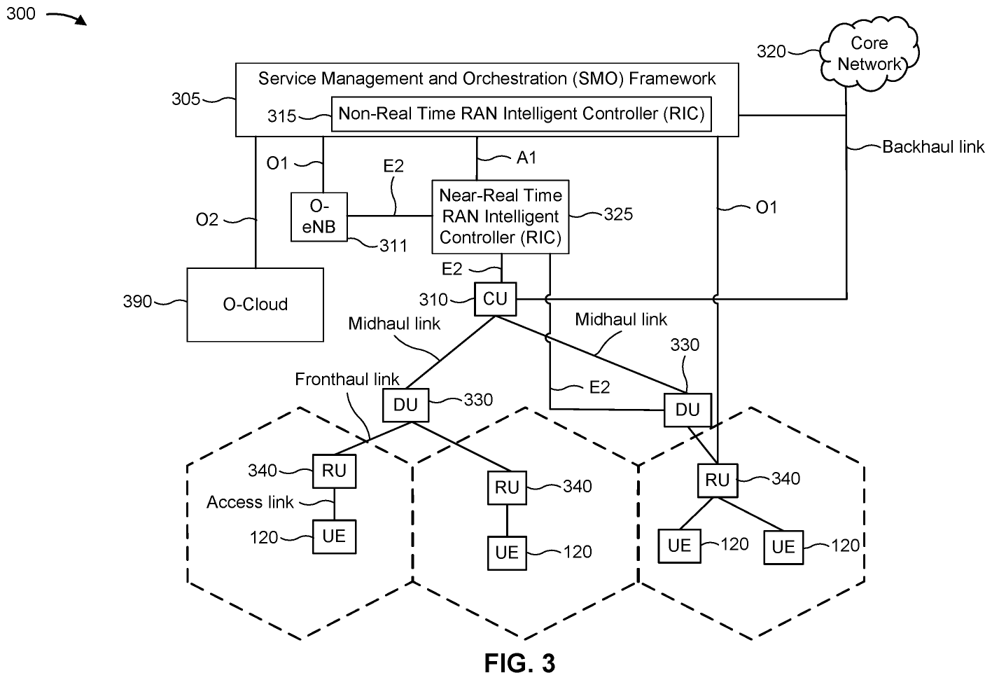

FIG. 3 is a diagram illustrating an example of a disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT MC 325 via an E2 link, or a Non-RT MC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an AI interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as AI interface policies).

As indicated above, FIG. 3 is provided as an example. Other examples may differ from what is described with regard to FIG. 3.

An antenna port(s) field in a downlink control information (DCI) format 1_1/1_2 may indicate a row of a lookup table identified by various RRC parameters. The lookup table may be associated with a 3GPP Technical Specification (TS) Release 17 and later (e.g., TS 38.212). The RRC parameters may be associated with a number of codewords (CWs), a DMRS type, a maximum length, and/or a number of transmission configuration indication (TCI) states per TCI codepoint.

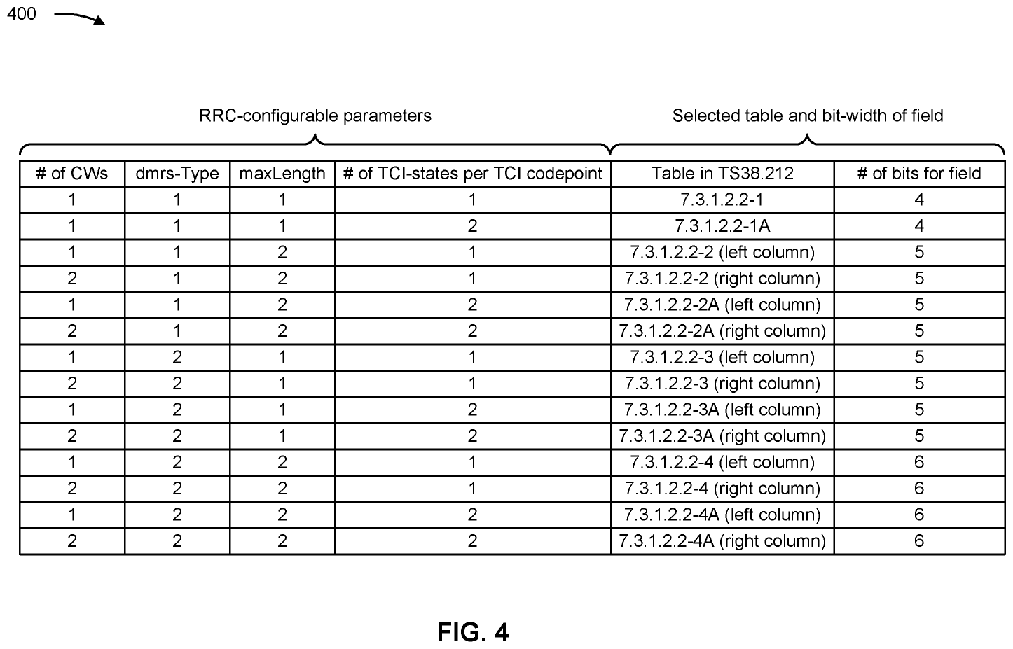

FIG. 4 is a diagram illustrating an example 400 of a plurality of lookup tables and corresponding RRC configurable parameters, in accordance with the present disclosure.

As shown in FIG. 4, a set of RRC configurable parameters may correspond to a certain lookup table in a 3GPP TS (e.g., TS 38.212), and in some cases, a left column or a right column of the certain lookup table. The set of RRC configurable parameters may include a number of CWs (e.g., one or two), a DMRS type (e.g., one or two), a maximum length (e.g., one or two), and/or a number of TCI states per TCI codepoint (e.g., one or two). A lookup table may be associated with an antenna port(s) field, which may be associated with a number of bits (e.g., 4, 5, or 6 bits).

As indicated above, FIG. 4 is provided as an example. Other examples may differ from what is described with regard to FIG. 4.

In some cases, the antenna port(s) field may be five bits (e.g., the antenna port(s) field associated with Table 7.3.1.2.2-3 may be five bits). The antenna port(s) field may indicate values for one codeword or for two codewords. Values for the one codeword may be associated with a left column of a lookup table, and values for the second codeword may be associated with a right column of the lookup table. For a component carrier with two CWs configured, the DCI may carry two MCS or redundancy version (RV) fields for the two CWs. Whether values for the one codeword or values for the two codewords are used (e.g., whether the left portion or the right portion of the lookup table is to be used) may depend on whether a scheduled physical downlink shared channel (PDSCH) carries one CW (e.g., one transport block TB)) or two CWs (e.g., two TBs). The scheduled PDSCH may carry the two CWs when an RRC parameter, such as a maximum number of CWs scheduled by DCI (maxNrofCodeWordsScheduledByDCI) RRC parameter, is set to “n2” and the DCI does not indicate {MCS=26, RV=1}, where MCS=26 and RV=1 may correspond to a special combination that indicates a CW (e.g., a TB) is disabled.

An MCS for a TB may indicate a row of an MCS table identified by various conditions. The MCS table may be associated with a 3GPP TS (e.g., TS 38.214). The various conditions may include an MCS cell radio network temporary identifier (MCS-C-RNTI) for a cell group (e.g., configured or not configured), an RRC configuration of the MCS table (e.g., set to quadrature amplitude modulation (QAM) 1024, set to QAM 256, etc.), a DCI format (e.g., DCI format 1_1, 1_2, etc.), and an RNTI scrambling cyclic redundancy check (CRC) of the DCI.

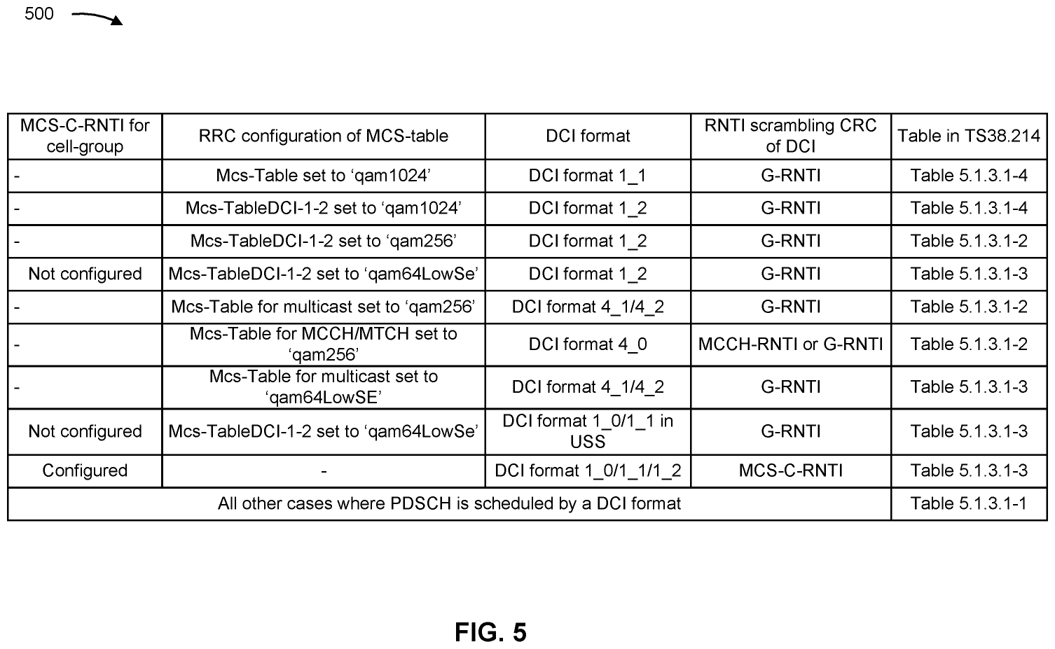

FIG. 5 is a diagram illustrating an example 500 of a plurality of lookup tables and corresponding conditions, in accordance with the present disclosure.

As shown in FIG. 5, a set of conditions may correspond to a certain lookup table in a 3GPP TS (e.g., TS 38.214). A lookup table may be associated with an MCS field (or an MCS index table). The conditions may include an MCS-C-RNTI for a cell group, an RRC configuration of an MCS table, a DCI format, and an RNTI scrambling CRC of the DCI. The MCS-C-RNTI for the cell group may be configured or not configured. The RRC configuration of the MCS table may correspond to Mcs-Table set to “qam1024”, Mcs-TableDCI-1-2 set to “qam1024”, Mcs-TableDCI-1-2 set to “qam256”, Mcs-TableDCI-1-2 set to “qam64LowSE”, Mcs-Table set to “qam256”, Mcs-Table for multicast set to “qam256”, Mcs-Table for multicast control channel (MCCH) or multicast traffic channel (MTCH) set to “qam256”, Mcs-Table for multicast set to “qam64LowSE”, or Mcs-table set to “qam64LowSE”. The DCI format may be DCI format 1_1, DCI format 1_2, DCI format 4_1/4_2, DCI format 4_0, DCI format 1_0/1_1 in a UE-specific search space (USS), or DCI format 1_0/1_1/1_2. The RNTI scrambling CRC of the DCI may be a C-RNTI, a group RNTI (G-RNTI), an MCCH-RNTI, or an MCS-C-RNTI.

As indicated above, FIG. 5 is provided as an example. Other examples may differ from what is described with regard to FIG. 5.

A multi-cell physical uplink shared channel (PUSCH) or physical downlink shared channel (PDSCH) scheduling may be achieved using a single DCI. The multi-cell PUSCH/PDSCH scheduling may be associated with one PDSCH/PUSCH per cell and may be associated with the single DCI. The multi-cell PUSCH/PDSCH scheduling may be subjected to a maximum number of cells that are allowed to be scheduled simultaneously. The multi-cell PUSCH/PDSCH scheduling may be applicable for both intra-band and inter-band carrier aggregation operations. The multi-cell PUSCH/PDSCH scheduling may be applicable for both FR1 and FR2. The single DCI may be optimized for three or more cells for the multi-cell PUSCH/PDSCH scheduling. The multi-cell PUSCH/PDSCH scheduling may be associated with co-scheduled component carriers having different bandwidths (e.g., 5 MHz and 10 MHz) or same bandwidths (e.g., 100 MHz).

However, for a DCI enabling multi-cell scheduling, or a multi-cell downlink control information (MC-DCI), antenna port(s) fields and MCS fields may need to be redefined because having the antenna port(s) fields and the MCS fields for each of the co-scheduled component carriers by the MC-DCI may significantly increase a DCI overhead. For example, using antenna port(s) fields and MCS fields for each of two component carriers (CCs) (or two cells) scheduled by the MC-DCI may result in twice as many bits as compared to a single CC (or single cell), thereby increasing a signaling overhead.

In various aspects of techniques and apparatuses described herein, a UE may receive, from a network node, an MC-DCI that indicates scheduling information for co-scheduled CCs. The MC-DCI may indicate an antenna port(s) field and/or an MCS field to be commonly applied to one or more of the co-scheduled CCs. In some aspects, the co-scheduled CCs may be associated with a same number of codewords, a same DMRS type, a same maximum length, and/or a same number of TCI states per TCI codepoint. The antenna port(s) field for the co-scheduled CCs may be a common lookup table for the co-scheduled CCs. In some aspects, an MCS table DCI RRC parameter may be set to the same value from QAM 1024, QAM 256, or QAM 64 low spectral efficiency for the co-scheduled CCs, or the MCS table DCI RRC parameter may not be configured for any of the co-scheduled CCs. The UE and/or the network node may perform a transmission based at least in part on the scheduling information indicated by the MC-DCI. In some aspects, by commonly indicating the antenna port(s) field and/or the MCS field for the co-scheduled CCs in the MC-DCI, a size of the MC-DCI may be reduced and a signaling overhead associated with transmitting the MC-DCI may be reduced, thereby saving power at the UE and/or the network node.

FIG. 6 is a diagram illustrating an example 600 associated with communicating MC-DCI, in accordance with the present disclosure. As shown in FIG. 6, example 600 includes communication between a UE (e.g., UE 120) and a network node (e.g., network node 110). In some aspects, the UE and the network node may be included in a wireless network, such as wireless network 100.

As shown by reference number 602, the UE may receive, from the network node, an MC-DCI that indicates scheduling information for co-scheduled CCs. The MC-DCI may indicate an antenna port(s) field and/or an MCS field to be commonly applied to one or more of the co-scheduled CCs. In some aspects, the co-scheduled CCs may be associated with a same number of CWs, a same DMRS type, a same maximum length, and/or a same number of TCI states per TCI codepoint. The antenna port(s) field for the co-scheduled CCs may be a common lookup table for the co-scheduled CCs. In some aspects, an MCS table DCI RRC parameter may be set to QAM 1024, QAM 256, or QAM 64 low spectral efficiency for the co-scheduled CCs, or the MCS table DCI RRC parameter may not be configured for any of the co-scheduled CCs. In some cases, the MCS table DCI RRC parameter may be defined as a per-CC parameter, and a same MCS table DCI RRC parameter may be associated with each of the co-scheduled CCs.

In some aspects, the network node may transmit, to the UE, the MC-DCI for the multi-cell scheduling. The multi-cell scheduling may be for the co-scheduled CCs. The MC-DCI may indicate a field, such as the antenna port(s) field and/or the MCS field, which may be commonly applied to one or more of the co-scheduled CCs. The MC-DCI may include the common indication for the co-scheduled CCs. For co-scheduled CCs for which an antenna port(s) field applies commonly, a same lookup table may be used. The lookup table may be associated with the antenna port(s) field.

In some aspects, for co-scheduled CCs, the number of CWs, the DMRS type, the maximum length, and the number of TCI states per TCI codepoint may be the same, such that the antenna port(s) field for the co-scheduled CCs may refer to a common lookup table. Relevant RRC parameters for each CC may be configured such that an antenna port(s) field refers to the same lookup table for all of the co-scheduled CCs. For example, a same set of RRC parameters (e.g., a number of CWs equal to two, a DMRS type of one, a maximum length of one, and one TCI state per TCI codepoint) may be associated with all of the co-scheduled CCs.

In some aspects, the MC-DCI may indicate the antenna port(s) field and/or the MCS field for a first sub-group and a second sub-group. The first sub-group may be associated with a first subset of CCs of the co-scheduled CCs and the second sub-group may be associated with a second subset of CCs of the co-scheduled CCs. The MC-DCI may indicate a common indication field that applies to a subset of co-scheduled CCs, of the co-scheduled CCs, associated with a sub-group, and different bits in the MC-DCI may be used for subsets of co-scheduled CCs in different sub-groups. The subset of co-scheduled CCs, of the co-scheduled CCs, in the sub-group may be associated with the same RRC parameters. In some aspects, a sub-grouping of the co-scheduled CCs may be based at least in part on dedicated RRC parameters, and the UE may be configured with an association between each of the co-scheduled CCs and each sub-group using the dedicated RRC parameters. In some aspects, a sub-grouping of the co-scheduled CCs may be based at least in part on whether the co-scheduled CCs are associated with a same antenna port(s) field or MCS field.

When the field in the MC-DCI, such as the antenna port(s) field and/or the MCS field, applies to all of the co-scheduled CCs, the indication may not be optimal for all of the co-scheduled CCs. The co-scheduled CCs may be associated with different frequency bands, operated with different RF components/chains, or may have different bandwidths. Thus, a common indication for all of the co-scheduled CCs may cause some performance degradation when the co-scheduled CCs do not have the same physical characteristics.

In some aspects, the MC-DCI may be associated with the sub-grouping of co-scheduled CCs. The MC-DCI may support sub-groups of the co-scheduled CCs, and the common indication field may apply to co-scheduled CCs associated with the sub-group. For example, for four co-scheduled CCs, two CCs may be associated with sub-group 1 and another two CCs may be associated with sub-group 2. In this example, the MC-DCI may include two copies of a particular field, and each copy of the particular field may apply to each sub-group. Different bit(s) in the MC-DCI may be used for the co-scheduled CCs in different sub-groups.

In some aspects, for co-scheduled CCs in a sub-group, a field (e.g., an antenna port(s) field or MCS field) may indicate the value of a common table. Thus, RRC parameter(s) may be configured to be the same among co-scheduled CCs in the sub-group.

In some aspects, for a sub-grouping configuration, a sub-grouping may be explicitly determined by dedicated RRC parameters. A UE may be configured with an association between each of the co-scheduled CCs and each of the sub-groups by specific RRC parameter(s). When the UE is configured with multiple sub-groups, the UE may consider an MC-DCI for the co-scheduled CCs to have two particular fields (e.g., antenna port(s) field and MCS field) and each of the fields may be for each of the sub-groups. When all of the co-scheduled CCs have the same RRC configurations, more than one sub-group may be configured.

In some aspects, for a sub-grouping configuration, a sub-grouping may be implicitly determined based at least in part on whether co-scheduled CCs use the same lookup table. For example, when all of the co-scheduled CCs have the same set of RRC configurations with respect to a number of CWs, a DMRS type, a maximum length, a number of TCI states, and an MCS table, a UE may consider an MC-DCI for the co-scheduled CCs to have only one particular field (e.g., an antenna port(s) field or MCS field). When two sets of co-scheduled CCs have the same set of RRC configurations with respect to a number of CWs, a DMRS type, a maximum length, a number of TCI states, and an MCS table, the UE may consider an MC-DCI for the co-scheduled CCs to have two particular fields (e.g., antenna port(s) field and MCS field) and each of the two particular fields may be for each sub-group. Duplicated field(s) may be present in the MC-DCI when different RRC configurations are used for the co-scheduled CCs.

In some aspects, a sub-grouping may be for multiple different configurations for co-scheduled cells by an MC-DCI. The sub-grouping may be a cell-level sub-grouping. For example, all bandwidth part (BWP) configurations for a given cell may be associated with a sub-group. Alternatively, the sub-grouping may be a BWP-level sub-grouping. For example, each BWP configuration for a given cell may be associated with a sub-group.

In some aspects, a sub-grouping of the co-scheduled CCs may be a cell-level sub-grouping. A plurality of bandwidth part configurations for a given cell may be associated with a sub-group. A BWP may be switchable (e.g., dynamically switchable or semi-statically switchable) on each CC without changing the sub-grouping of the co-scheduled CCs. In some aspects, a sub-grouping of the co-scheduled CCs may be a BWP-level sub-grouping. Each BWP configuration for a given cell may be associated with a sub-group. A BWP switching on a certain CC may change the sub-grouping of the co-scheduled CCs.

In some aspects, the MC-DCI may include an RRC parameter that indicates for which sub-groups of co-scheduled CCs an MCS index lookup table is used when the MC-DCI is with an MCS-C-RNTI. In some aspects, the MC-DCI may include an RRC parameter for each CC of the co-scheduled CCs that indicates for which CCs the MCS index lookup table is used when the MC-DCI is with the MCS-C-RNTI. In some aspects, the antenna port(s) field may indicate a value of antenna port(s) for two CWs and a value of an MCS index for CCs of the co-scheduled CCs in which both CWs are not disabled, or the antenna port(s) field may indicate a value of antenna port(s) for one CW for CCs of the co-scheduled CCs in which a CW is disabled. In some aspects, an MCS for CCs in which a CW is disabled and a value of antenna port(s) for CCs in which the CW is disabled may be configured via RRC signaling for each value of the antenna port(s) field.

As shown by reference number 604, the UE and/or the network node may perform a transmission based at least in part on the scheduling information indicated by the MC-DCI. For example, the UE may transmit, to the network node, an uplink transmission based at least in part on the scheduling information indicated by the MC-DCI. The uplink transmission may be a PUSCH transmission. As another example, the network node may transmit, to the UE, a downlink transmission based at least in part on the scheduling information indicated by the MC-DCI. The downlink transmission may be a PDSCH transmission.

As indicated above, FIG. 6 is provided as an example. Other examples may differ from what is described with regard to FIG. 6.

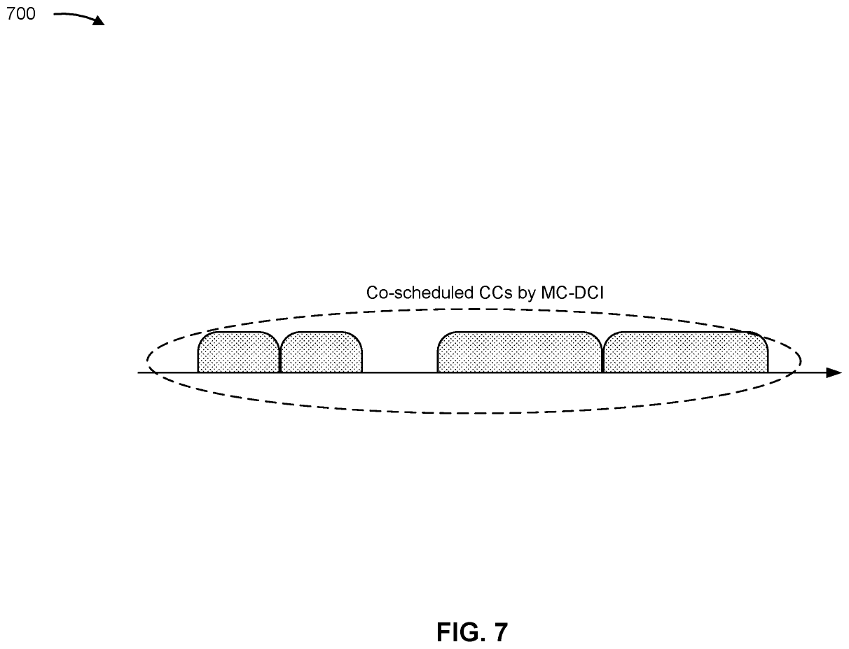

FIG. 7 is a diagram illustrating an example 700 associated with communicating MC-DCI, in accordance with the present disclosure.

As shown in FIG. 7, an MC-DCI may be associated with co-scheduled CCs. The co-scheduled CCs may be associated with different bandwidths. Some of the co-scheduled CCs may be associated with contiguous bandwidths. Some of the co-scheduled CCs may be associated with non-contiguous bandwidths. The MC-DCI may indicate a field, such as an antenna port(s) field and/or an MCS field, that applies commonly to the co-scheduled CCs.

As indicated above, FIG. 7 is provided as an example. Other examples may differ from what is described with regard to FIG. 7.

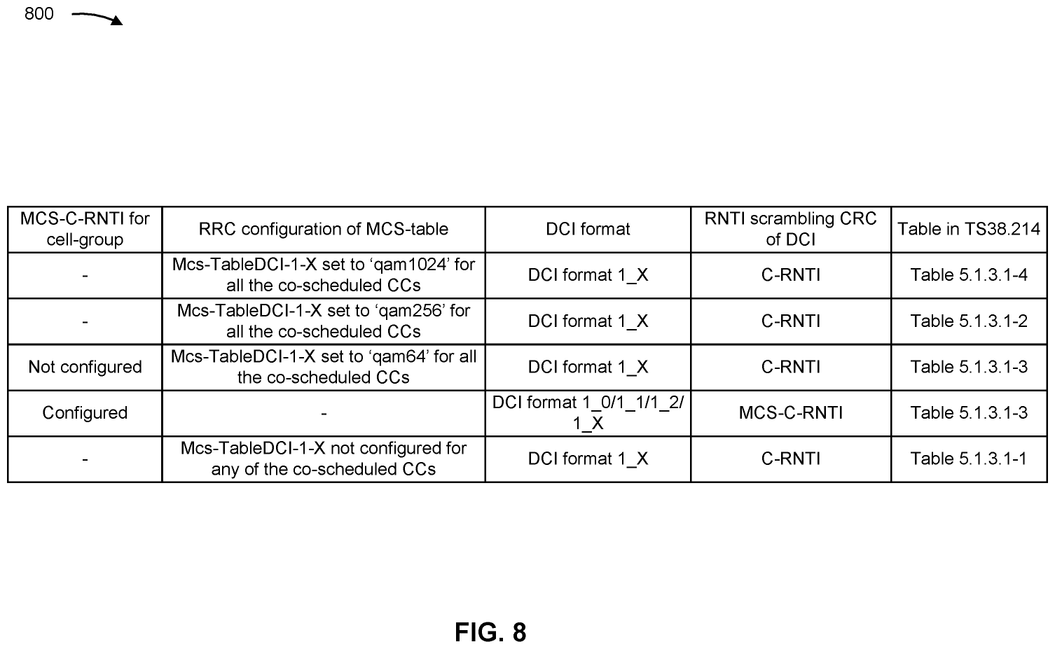

FIG. 8 is a diagram illustrating an example 800 associated with communicating MC-DCI, in accordance with the present disclosure.

As shown in FIG. 8, for co-scheduled CCs, an Mcs-TableDCI-1-XRRC parameter may be set to the same value from ‘qam1024’, ‘qam256’, ‘qam64LowSE’ if configured, or the Mcs-TableDCI-1-XRRC parameter may not be configured for any of the co-scheduled CCs. When the Mcs-TableDCI-1-XRRC parameter is defined as a per-CC parameter, the Mcs-TableDCI-1-XRRC parameter for each of the co-scheduled CCs may be set to the same value if configured, and if not configured for any of the co-scheduled CCs, the Mcs-TableDCI-1-XRRC parameter may not be configured for all of the co-scheduled CCs.

As indicated above, FIG. 8 is provided as an example. Other examples may differ from what is described with regard to FIG. 8.

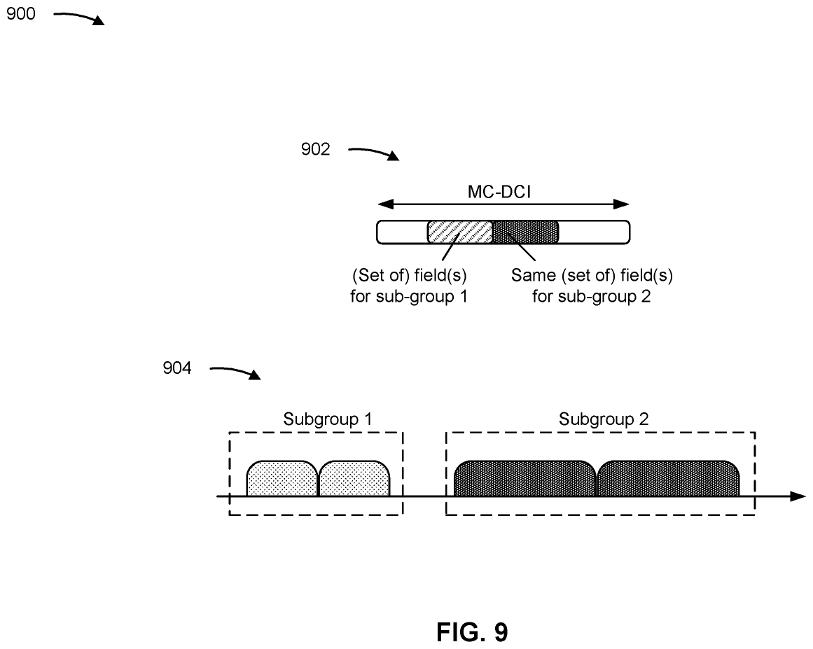

FIG. 9 is a diagram illustrating an example 900 associated with communicating MC-DCI, in accordance with the present disclosure.

As shown by reference number 902, an MC-DCI may indicate field(s) for a first sub-group (or a set of field(s) for the first sub-group). The MC-DCI may indicate the same field(s) for a second sub-group (or a same set of field(s) for the second sub-group). The first sub-group may be associated with a first set of co-scheduled CCs, and the second sub-group may be associated with a second set of co-scheduled CCs. A common indication field may be applied to co-scheduled CCs associated with the first sub-group, and a common indication field may be applied to co-scheduled CCs associated with the second sub-group.

As shown by reference number 904, an MC-DCI may be associated with a first sub-group of co-scheduled CCs and a second sub-group of co-scheduled CCs. The first sub-group may be associated with co-scheduled CCs of similar bandwidths. The second sub-group may be associated with co-scheduled CCs of similar bandwidths. Bandwidths of CCs associated with the first sub-group may be different in size as compared to bandwidths of CCs associated with the second sub-group.

As indicated above, FIG. 9 is provided as an example. Other examples may differ from what is described with regard to FIG. 9.

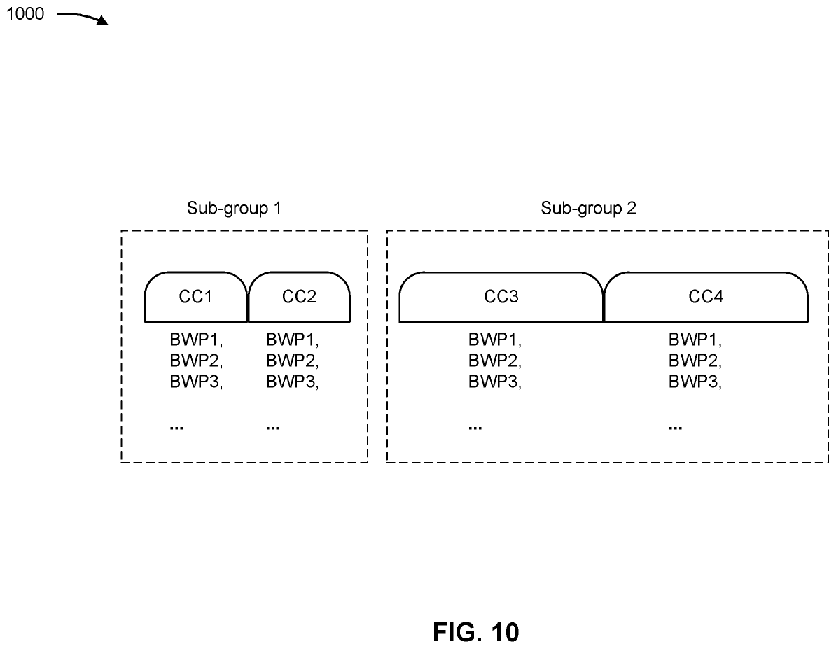

FIG. 10 is a diagram illustrating an example 1000 associated with communicating MC-DCI, in accordance with the present disclosure.

As shown in FIG. 10, a first sub-group may be associated with CC1 and CC2. CC1 may be associated with BWP1, BWP2, and BWP3. CC2 may be associated with BWP1, BWP2, and BWP3. A second sub-group may be associated with CC3 and CC4. CC3 may be associated with BWP1, BWP2, and BWP3. CC4 may be associated with BWP1, BWP2, and BWP3. A BWP may be switched on each CC dynamically, but a BWP switching may not change the sub-grouping (e.g., a network may guarantee that the BWP switching does not change the sub-grouping).

As indicated above, FIG. 10 is provided as an example. Other examples may differ from what is described with regard to FIG. 10.

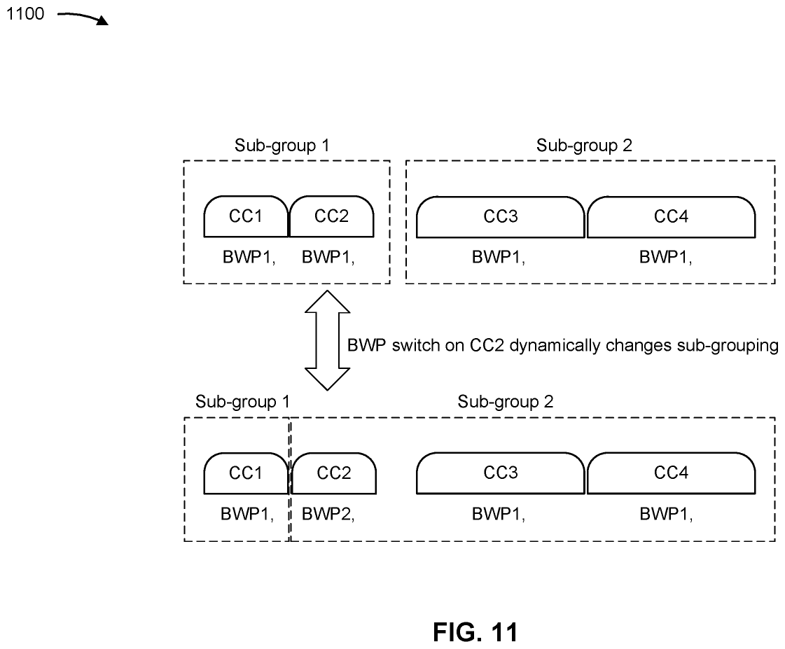

FIG. 11 is a diagram illustrating an example 1100 associated with communicating MC-DCI, in accordance with the present disclosure.

As shown in FIG. 11, a first sub-group may be associated with CC1 and CC2. CC1 and CC2 may each be associated with BWP1. A second sub-group may be associated with CC3 and CC4. CC3 and CC4 may each be associated with BWP1. A BWP switching on CC2 may dynamically change the sub-grouping. After the BWP switching, the first sub-group may be associated with CC1, and the second sub-group may be associated with CC2, CC3, and CC4. CC2 may be associated with BWP2, and CC3 and CC4 may each be associated with BWP1.

As indicated above, FIG. 11 is provided as an example. Other examples may differ from what is described with regard to FIG. 11.

In some aspects, when an MCS-C-RNTI is configured and when a CRC of a DCI format is scrambled with the MCS-C-RNTI, a UE may consider a certain lookup table (e.g., an MCS table from TS 5.1.3.1-3) to be used. When the MCS-C-RNTI is configured but the CRC of the DCI format is scrambled with a C-RNTI, the UE may consider another lookup table (e.g., an MCS table from TS 5.1.3.1-1/2/4) to be used. A CRC scrambling RNTI may dynamically indicate which MCS table (e.g., the MCS table from TS 5.1.3.1-3 versus the MCS table from TS 5.1.3.1-1/2/4) is to be used for data. The MCS table may be common for all co-scheduled CCs by an MC-DCI.

In some aspects, when more than one sub-group is present for co-scheduled CCs by an MC-DCI, an MCS alignment may be within the sub-group but not across sub-groups. Thus, an MCS table determination by an RNTI that scrambles a CRC may also be per sub-group. For example, when an MC-DCI is with a CRC scrambled by an MCS-C-RNTI, a lookup table from TS 5.1.3.1-3 may be used for co-scheduled CCs in one sub-group but another lookup table from TS 5.1.3.1-1/2/4 may be able to be used for CCs in the other sub-group. In some aspects, an RRC parameter may be added to indicate for which sub-group(s) the lookup table from TS 5.1.3.1-3 may be used when the MC-DCI is with the MCS-C-RNTI. For other sub-group(s), even when the MC-DCI is with the MCS-C-RNTI, a configured lookup table from TS 5.1.3.1-1/2/4 may be used. In some aspects, an RRC parameter may be added for each CC to indicate for which CC(s) the lookup table from TS 5.1.3.1-3 may be used when the MC-DCI is with the MCS-C-RNTI. Regardless of which sub-group a CC is associated with, depending on this RRC parameter and whether the MC-DCI is with the MCS-C-RNTI or a C-RNTI, an MCS table for the CC may be from either TS 5.1.3.1-3 or TS 5.1.3.1-1/2/4.

In a legacy DCI, one of the CWs/TBs may be disabled by a DCI when MCS=26 and RV=1 for a TB. For an MC-DCI, an MCS field may be common for a CW for CCs in a sub-group and an RV may be separate for each CW for each CC. A particular combination of {MCS, RV} for a CW for CCs in a sub-group may indicate the corresponding CW for the CCs that is disabled (e.g., MCS=26 and RV=1 or 2). However, for CCs that do not disable the CW, the MCS for the CW may be automatically fixed to the particular value (e.g., 26). Further, antenna port(s) may be common for all CCs in the sub-group, and hence, indicating a value for a CC with one CW disabled and for a CC with both CWs enabled may be difficult to operate.

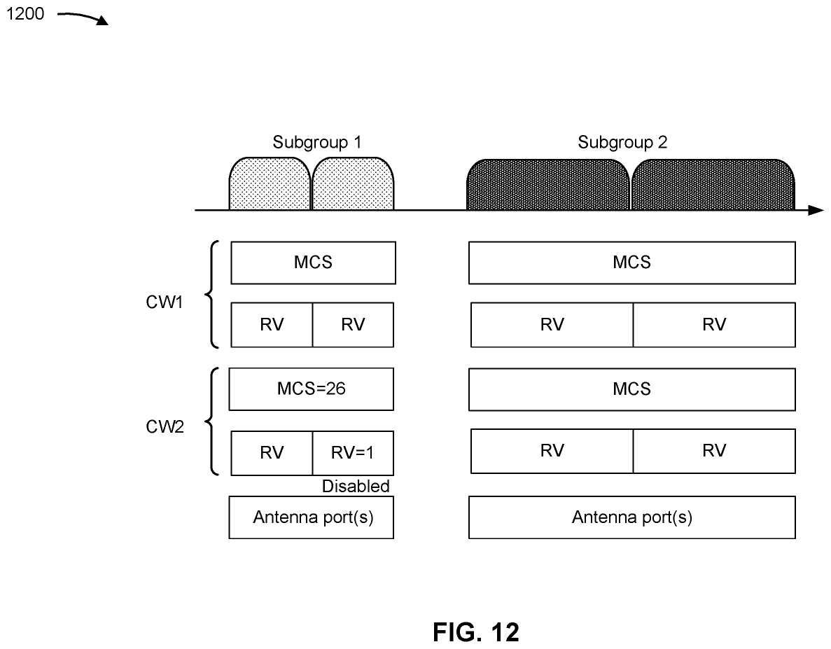

FIG. 12 is a diagram illustrating an example 1200 associated with communicating MC-DCI, in accordance with the present disclosure.

As shown in FIG. 12, a first sub-group may be associated with a first CC and a second CC. For a first CW, an MCS may be associated with the first CC and the second CC, a first RV may be associated with the first CC, and a second RV may be associated with the second CC. For a second CW, an MCS may be associated with the first CC and the second CC, a first RV may be associated with the first CC, and a second RV may be associated with the second CC. A second sub-group may have a similar structure as compared to the first sub-group. In a specific example, in the first sub-group, the MCS associated with the second CW may correspond to MCS=26, and a second RV associated with the second CW and the second CC may correspond to RV=1. In this case, a corresponding CW for the second CC may be disabled.

As indicated above, FIG. 12 is provided as an example. Other examples may differ from what is described with regard to FIG. 12.

In some aspects, a particular combination of {MCS, RV} for CC(s) in a sub-group may indicate the corresponding CW (e.g., a second CW) for the CC that is disabled (e.g., MCS=26 and RV=1 or 2). An antenna port(s) field for CCs of a sub-group may be interpreted in various manners. For CC(s) in which both CWs are not disabled, the antenna port(s) field may indicate a value of antenna port(s) for two CWs, and the antenna port(s) field may also indicate a value of MCS index. For CC(s) in which the CW is disabled, the antenna port(s) field may indicate a value of antenna port(s) for one CW. The MCS for CCs in which the CW is not disabled and the value of antenna port(s) for CCs in which the CW is disabled may be configured by RRC signaling for each value of the antenna port(s) field.

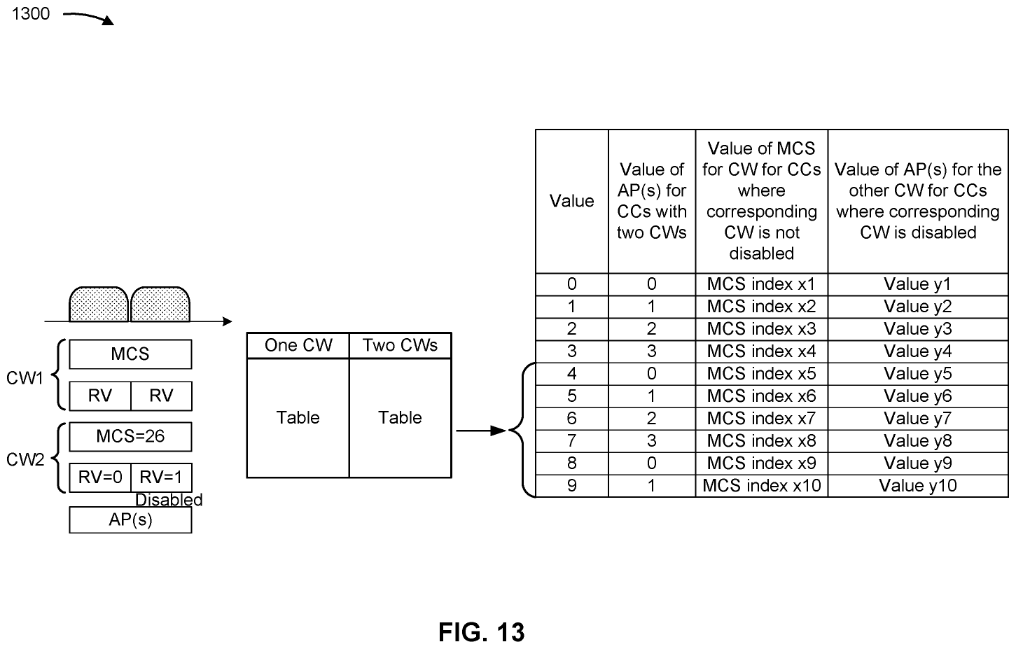

FIG. 13 is a diagram illustrating an example 1300 associated with communicating MC-DCI, in accordance with the present disclosure.

As shown in FIG. 13, a particular combination of {MCS, RV} for CC(s) in a sub-group may indicate that the corresponding CW (e.g., a second CW) for the CC is disabled (e.g., MCS=26 and RV=1 or 2). In an antenna port(s) field for CCs of the sub-group, a value may correspond to a value of antenna port(s) for CCs with two CWs (e.g., 0, 1, 2, or 3), a value of MCS (e.g., an MCS index) for a CW for CCs in which a corresponding CW is not disabled, and a value of antenna port(s) for the other CW for CCs in which a corresponding CW is disabled. Thus, for the antenna port(s) field for the CCs of the sub-group, the MCS for CCs in which the CW is not disabled and the value of antenna port(s) for CCs in which the CW is disabled may be configured by RRCs for each value of the antenna port(s) field.

As indicated above, FIG. 13 is provided as an example. Other examples may differ from what is described with regard to FIG. 13.

FIG. 14 is a diagram illustrating an example process 1400 performed, for example, by a UE, in accordance with the present disclosure. Example process 1400 is an example where the UE (e.g., UE 120) performs operations associated with communicating MC-DCI.

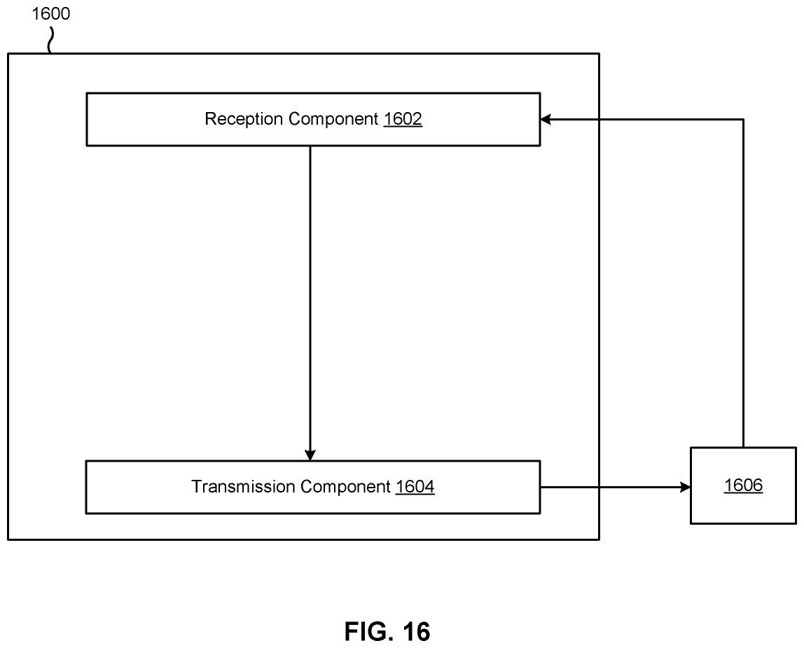

As shown in FIG. 14, in some aspects, process 1400 may include receiving, from a network node, an MC-DCI that indicates scheduling information for co-scheduled CCs, wherein the MC-DCI indicates one or more of an antenna port(s) field or an MCS field to be commonly applied to one or more of the co-scheduled CCs (block 1410). For example, the UE (e.g., using reception component 1602, depicted in FIG. 16) may receive, from a network node, an MC-DCI that indicates scheduling information for co-scheduled CCs, wherein the MC-DCI indicates one or more of an antenna port(s) field or an MCS field to be commonly applied to one or more of the co-scheduled CCs, as described above.

As further shown in FIG. 14, in some aspects, process 1400 may include performing a transmission based at least in part on the scheduling information indicated by the MC-DCI (block 1420). For example, the UE (e.g., using reception component 1602 and/or transmission component 1604, depicted in FIG. 16) may perform a transmission based at least in part on the scheduling information indicated by the MC-DCI, as described above.

Process 1400 may include additional aspects, such as any single aspect or any combination of aspects described below and/or in connection with one or more other processes described elsewhere herein.

In a first aspect, the co-scheduled CCs are associated with one or more of a same number of codewords, a same DMRS type, a same maximum length, and a same number of TCI states per TCI codepoint, and the antenna port(s) field for the co-scheduled CCs is a common lookup table for the co-scheduled CCs.

In a second aspect, alone or in combination with the first aspect, an MCS table DCI RRC parameter is set to QAM 1024, QAM 256, or QAM 64 low spectral efficiency for the co-scheduled CCs, or the MCS table DCI RRC parameter is not configured for any of the co-scheduled CCs.

In a third aspect, alone or in combination with one or more of the first and second aspects, an MCS table DCI RRC parameter is defined as a per-CC parameter, and a same MCS table DCI RRC parameter is associated with each of the co-scheduled CCs.

In a fourth aspect, alone or in combination with one or more of the first through third aspects, the MC-DCI indicates one or more of the antenna port(s) field or the MCS field for a first sub-group and a second sub-group, wherein the first sub-group is associated with a first subset of CCs of the co-scheduled CCs and the second sub-group is associated with a second subset of CCs of the co-scheduled CCs.

In a fifth aspect, alone or in combination with one or more of the first through fourth aspects, the MC-DCI indicates a common indication field that applies to a subset of co-scheduled CCs, of the co-scheduled CCs, associated with a sub-group, and different bits in the MC-DCI are used for subsets of co-scheduled CCs in different sub-groups.

In a sixth aspect, alone or in combination with one or more of the first through fifth aspects, a subset of co-scheduled CCs, of the co-scheduled CCs, in a sub-group are associated with same RRC parameters.

In a seventh aspect, alone or in combination with one or more of the first through sixth aspects, a sub-grouping of the co-scheduled CCs is based at least in part on dedicated RRC parameters, and the UE is configured with an association between each of the co-scheduled CCs and each sub-group using the dedicated RRC parameters.

In an eighth aspect, alone or in combination with one or more of the first through seventh aspects, a sub-grouping of the co-scheduled CCs is based at least in part on whether the co-scheduled CCs are associated with a same antenna port(s) field or MCS field.

In a ninth aspect, alone or in combination with one or more of the first through eighth aspects, a sub-grouping of the co-scheduled CCs is a cell-level sub-grouping, wherein a plurality of bandwidth part configurations for a given cell are associated with a sub-group, and a BWP is switchable on each CC without changing the sub-grouping of the co-scheduled CCs.

In a tenth aspect, alone or in combination with one or more of the first through ninth aspects, a sub-grouping of the co-scheduled CCs is a BWP-level sub-grouping, wherein each BWP configuration for a given cell is associated with a sub-group, and a BWP switching on a certain CC changes the sub-grouping of the co-scheduled CCs.

In an eleventh aspect, alone or in combination with one or more of the first through tenth aspects, the MC-DCI includes an RRC parameter that indicates for which sub-groups of co-scheduled CCs an MCS index lookup table is used when the MC-DCI is with an MCS-C-RNTI, or the MC-DCI includes an RRC parameter for each CC of the co-scheduled CCs that indicates for which CCs the MCS index lookup table is used when the MC-DCI is with the MCS-C-RNTI.

In a twelfth aspect, alone or in combination with one or more of the first through eleventh aspects, the antenna port(s) field indicates a value of antenna port(s) for two codewords and a value of an MCS index for CCs of the co-scheduled CCs in which both codewords are not disabled, or the antenna port(s) field indicates a value of antenna port(s) for one codeword for CCs of the co-scheduled CCs in which a codeword is disabled.

In a thirteenth aspect, alone or in combination with one or more of the first through twelfth aspects, an MCS for CCs in which a codeword is disabled and a value of antenna port(s) for CCs in which the codeword is disabled are configured via RRC signaling for each value of the antenna port(s) field.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, by a network node, in accordance with the present disclosure. Example process 1500 is an example where the network node (e.g., network node 110) performs operations associated with communicating MC-DCI.

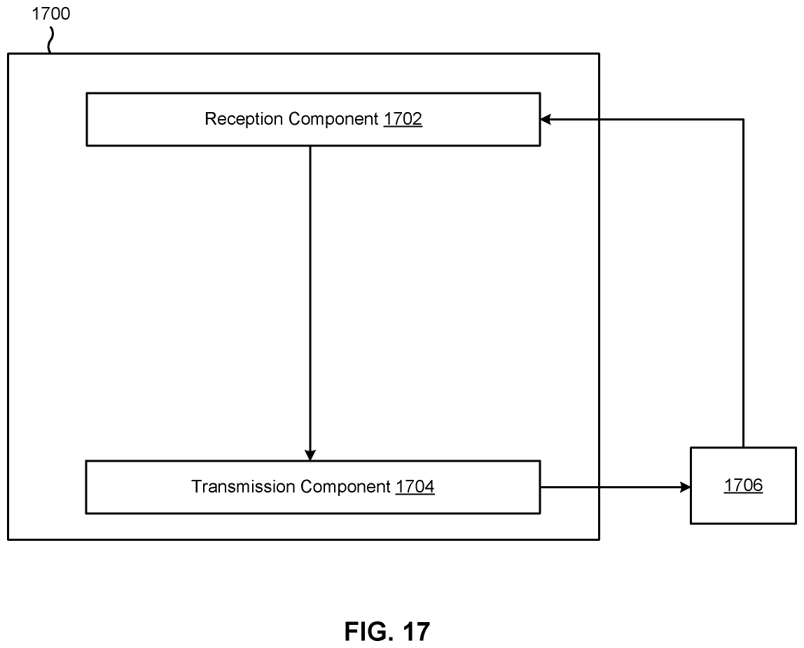

As shown in FIG. 15, in some aspects, process 1500 may include transmitting, to a UE, an MC-DCI that indicates scheduling information for co-scheduled CCs, wherein the MC-DCI indicates one or more of an antenna port(s) field or an MCS field to be commonly applied to one or more of the co-scheduled CCs (block 1510). For example, the network node (e.g., using transmission component 1704, depicted in FIG. 17) may transmit, to a UE, an MC-DCI that indicates scheduling information for co-scheduled CCs, wherein the MC-DCI indicates one or more of an antenna port(s) field or an MCS field to be commonly applied to one or more of the co-scheduled CCs, as described above.

As further shown in FIG. 15, in some aspects, process 1500 may include performing a transmission based at least in part on the scheduling information indicated by the MC-DCI (block 1520). For example, the network node (e.g., using reception component 1702 and/or transmission component 1704, depicted in FIG. 17) may perform a transmission based at least in part on the scheduling information indicated by the MC-DCI, as described above.

Process 1500 may include additional aspects, such as any single aspect or any combination of aspects described below and/or in connection with one or more other processes described elsewhere herein.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram of an example apparatus 1600 for wireless communication, in accordance with the present disclosure. The apparatus 1600 may be a UE, or a UE may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604.

In some aspects, the apparatus 1600 may be configured to perform one or more operations described herein in connection with FIGS. 6-13. Additionally, or alternatively, the apparatus 1600 may be configured to perform one or more processes described herein, such as process 1400 of FIG. 14. In some aspects, the apparatus 1600 and/or one or more components shown in FIG. 16 may include one or more components of the UE described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the UE described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the UE described in connection with FIG. 2. In some aspects, the transmission component 1604 may be co-located with the reception component 1602 in a transceiver.

The reception component 1602 may receive, from a network node, an MC-DCI that indicates scheduling information for co-scheduled CCs, wherein the MC-DCI indicates one or more of an antenna port(s) field or an MCS field to be commonly applied to one or more of the co-scheduled CCs. The reception component 1602 and/or transmission component 1604 may perform a transmission based at least in part on the scheduling information indicated by the MC-DCI.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

FIG. 17 is a diagram of an example apparatus 1700 for wireless communication, in accordance with the present disclosure. The apparatus 1700 may be a network node, or a network node may include the apparatus 1700. In some aspects, the apparatus 1700 includes a reception component 1702 and a transmission component 1704, which may be in communication with one another (for example, via one or more buses and/or one or more other components). As shown, the apparatus 1700 may communicate with another apparatus 1706 (such as a UE, a base station, or another wireless communication device) using the reception component 1702 and the transmission component 1704.

In some aspects, the apparatus 1700 may be configured to perform one or more operations described herein in connection with FIGS. 6-13. Additionally, or alternatively, the apparatus 1700 may be configured to perform one or more processes described herein, such as process 1500 of FIG. 15. In some aspects, the apparatus 1700 and/or one or more components shown in FIG. 17 may include one or more components of the network node described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1702 may receive communications, such as reference signals, control information, data communications, or a combination thereof, from the apparatus 1706. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, a modem, a demodulator, a MIMO detector, a receive processor, a controller/processor, a memory, or a combination thereof, of the network node described in connection with FIG. 2.

The transmission component 1704 may transmit communications, such as reference signals, control information, data communications, or a combination thereof, to the apparatus 1706. In some aspects, one or more other components of the apparatus 1700 may generate communications and may provide the generated communications to the transmission component 1704 for transmission to the apparatus 1706. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1706. In some aspects, the transmission component 1704 may include one or more antennas, a modem, a modulator, a transmit MIMO processor, a transmit processor, a controller/processor, a memory, or a combination thereof, of the network node described in connection with FIG. 2. In some aspects, the transmission component 1704 may be co-located with the reception component 1702 in a transceiver.

The transmission component 1704 may transmit, to a UE, an MC-DCI that indicates scheduling information for co-scheduled CCs, wherein the MC-DCI indicates one or more of an antenna port(s) field or an MCS field to be commonly applied to one or more of the co-scheduled CCs. The reception component 1702 and/or transmission component 1704 may perform a transmission based at least in part on the scheduling information indicated by the MC-DCI.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

The following provides an overview of some Aspects of the present disclosure:

Aspect 1: A method of wireless communication performed by a user equipment (UE), comprising: receiving, from a network node, a multi-cell downlink control information (MC-DCI) that indicates scheduling information for co-scheduled component carriers (CCs), wherein the MC-DCI indicates one or more of an antenna port(s) field or a modulation and coding scheme (MCS) field to be commonly applied to one or more of the co-scheduled CCs; and performing a transmission based at least in part on the scheduling information indicated by the MC-DCI.

Aspect 2: The method of Aspect 1, wherein the co-scheduled CCs are associated with one or more of: a same number of codewords, a same demodulation reference signal type, a same maximum length, and a same number of transmission configuration indication (TCI) states per TCI codepoint, and wherein the antenna port(s) field for the co-scheduled CCs is a common lookup table for the co-scheduled CCs.

Aspect 3: The method of any of Aspects 1 through 2, wherein: an MCS table downlink control information (DCI) radio resource control (RRC) parameter is set to quadrature amplitude modulation (QAM) 1024, QAM 256, or QAM 64 low spectral efficiency for the co-scheduled CCs; or the MCS table DCI RRC parameter is not configured for any of the co-scheduled CCs.

Aspect 4: The method of any of Aspects 1 through 3, wherein an MCS table downlink control information (DCI) radio resource control (RRC) parameter is defined as a per-CC parameter, and a same MCS table DCI RRC parameter is associated with each of the co-scheduled CCs.

Aspect 5: The method of any of Aspects 1 through 4, wherein the MC-DCI indicates one or more of the antenna port(s) field or the MCS field for a first sub-group and a second sub-group, wherein the first sub-group is associated with a first subset of CCs of the co-scheduled CCs and the second sub-group is associated with a second subset of CCs of the co-scheduled CCs.

Aspect 6: The method of any of Aspects 1 through 5, wherein the MC-DCI indicates a common indication field that applies to a subset of co-scheduled CCs, of the co-scheduled CCs, associated with a sub-group, and wherein different bits in the MC-DCI are used for subsets of co-scheduled CCs in different sub-groups.

Aspect 7: The method of any of Aspects 1 through 6, wherein a subset of co-scheduled CCs, of the co-scheduled CCs, in a sub-group are associated with same radio resource control parameters.

Aspect 8: The method of any of Aspects 1 through 7, wherein a sub-grouping of the co-scheduled CCs is based at least in part on dedicated radio resource control (RRC) parameters, and wherein the UE is configured with an association between each of the co-scheduled CCs and each sub-group using the dedicated RRC parameters.

Aspect 9: The method of any of Aspects 1 through 8, wherein a sub-grouping of the co-scheduled CCs is based at least in part on whether the co-scheduled CCs are associated with a same antenna port(s) field or MCS field.

Aspect 10: The method of any of Aspects 1 through 9, wherein a sub-grouping of the co-scheduled CCs is a cell-level sub-grouping, wherein a plurality of bandwidth part configurations for a given cell are associated with a sub-group, and wherein a BWP is switchable on each CC without changing the sub-grouping of the co-scheduled CCs.

Aspect 11: The method of any of Aspects 1 through 10, wherein a sub-grouping of the co-scheduled CCs is a bandwidth part (BWP)-level sub-grouping, wherein each BWP configuration for a given cell is associated with a sub-group, and wherein a BWP switching on a certain CC changes the sub-grouping of the co-scheduled CCs.

Aspect 12: The method of any of Aspects 1 through 11, wherein: the MC-DCI includes a radio resource control (RRC) parameter that indicates for which sub-groups of co-scheduled CCs an MCS index lookup table is used when the MC-DCI is with an MCS cell radio network temporary identifier (MCS-C-RNTI); or the MC-DCI includes an RRC parameter for each CC of the co-scheduled CCs that indicates for which CCs the MCS index lookup table is used when the MC-DCI is with the MCS-C-RNTI.

Aspect 13: The method of any of Aspects 1 through 12, wherein: the antenna port(s) field indicates a value of antenna port(s) for two codewords and a value of an MCS index for CCs of the co-scheduled CCs in which both codewords are not disabled; or the antenna port(s) field indicates a value of antenna port(s) for one codeword for CCs of the co-scheduled CCs in which a codeword is disabled.

Aspect 14: The method of any of Aspects 1 through 13, wherein an MCS for CCs in which a codeword is disabled and a value of antenna port(s) for CCs in which the codeword is disabled are configured via radio resource control signaling for each value of the antenna port(s) field.

Aspect 15: A method of wireless communication performed by a network node, comprising: transmitting, to a user equipment (UE), a multi-cell downlink control information (MC-DCI) that indicates scheduling information for co-scheduled component carriers (CCs), wherein the MC-DCI indicates one or more of an antenna port(s) field or a modulation and coding scheme (MCS) field to be commonly applied to one or more of the co-scheduled CCs; and performing a transmission based at least in part on the scheduling information indicated by the MC-DCI.

Aspect 16: An apparatus for wireless communication at a device, comprising a processor; memory coupled with the processor; and instructions stored in the memory and executable by the processor to cause the apparatus to perform the method of one or more of Aspects 1-14.

Aspect 17: A device for wireless communication, comprising a memory and one or more processors coupled to the memory, the one or more processors configured to perform the method of one or more of Aspects 1-14.

Aspect 18: An apparatus for wireless communication, comprising at least one means for performing the method of one or more of Aspects 1-14.

Aspect 19: A non-transitory computer-readable medium storing code for wireless communication, the code comprising instructions executable by a processor to perform the method of one or more of Aspects 1-14.

Aspect 20: A non-transitory computer-readable medium storing a set of instructions for wireless communication, the set of instructions comprising one or more instructions that, when executed by one or more processors of a device, cause the device to perform the method of one or more of Aspects 1-14.

Aspect 21: An apparatus for wireless communication at a device, comprising a processor; memory coupled with the processor; and instructions stored in the memory and executable by the processor to cause the apparatus to perform the method of Aspect 15.

Aspect 22: A device for wireless communication, comprising a memory and one or more processors coupled to the memory, the one or more processors configured to perform the method of Aspect 15.

Aspect 23: An apparatus for wireless communication, comprising at least one means for performing the method of Aspect 15.

Aspect 24: A non-transitory computer-readable medium storing code for wireless communication, the code comprising instructions executable by a processor to perform the method of Aspect 15.

Aspect 25: A non-transitory computer-readable medium storing a set of instructions for wireless communication, the set of instructions comprising one or more instructions that, when executed by one or more processors of a device, cause the device to perform the method of Aspect 15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A method of wireless communication performed by a user equipment (UE), comprising:
receiving, from a network node, a multi-cell downlink control information (MC-DCI) that indicates scheduling information for co-scheduled component carriers (CCs), wherein the MC-DCI indicates one or more of an antenna port(s) field or a modulation and coding scheme (MCS) field to be commonly applied to one or more of the co-scheduled CCs; and
performing a transmission based at least in part on the scheduling information indicated by the MC-DCI.

2. The method of claim 1, wherein the co-scheduled CCs are associated with one or more of: a same number of codewords, a same demodulation reference signal type, a same maximum length, and a same number of transmission configuration indication (TCI) states per TCI codepoint, and wherein the antenna port(s) field for the co-scheduled CCs is a common lookup table for the co-scheduled CCs.

3. The method of claim 1, wherein:
an MCS table downlink control information (DCI) radio resource control (RRC) parameter is set to quadrature amplitude modulation (QAM) 1024, QAM 256, or QAM 64 low spectral efficiency for the co-scheduled CCs; or
the MCS table DCI RRC parameter is not configured for any of the co-scheduled CCs.

4. The method of claim 1, wherein an MCS table downlink control information (DCI) radio resource control (RRC) parameter is defined as a per-CC parameter, and a same MCS table DCI RRC parameter is associated with each of the co-scheduled CCs.

5. The method of claim 1, wherein the MC-DCI indicates one or more of the antenna port(s) field or the MCS field for a first sub-group and a second sub-group, wherein the first sub-group is associated with a first subset of CCs of the co-scheduled CCs and the second sub-group is associated with a second subset of CCs of the co-scheduled CCs.

6. The method of claim 1, wherein the MC-DCI indicates a common indication field that applies to a subset of co-scheduled CCs, of the co-scheduled CCs, associated with a sub-group, and wherein different bits in the MC-DCI are used for subsets of co-scheduled CCs in different sub-groups.

7. The method of claim 1, wherein a subset of co-scheduled CCs, of the co-scheduled CCs, in a sub-group are associated with same radio resource control parameters.

8. The method of claim 1, wherein a sub-grouping of the co-scheduled CCs is based at least in part on dedicated radio resource control (RRC) parameters, and wherein the UE is configured with an association between each of the co-scheduled CCs and each sub-group using the dedicated RRC parameters.

9. The method of claim 1, wherein a sub-grouping of the co-scheduled CCs is based at least in part on whether the co-scheduled CCs are associated with a same antenna port(s) field or MCS field.

10. The method of claim 1, wherein a sub-grouping of the co-scheduled CCs is a cell-level sub-grouping, wherein a plurality of bandwidth part configurations for a given cell are associated with a sub-group, and wherein a BWP is switchable on each CC without changing the sub-grouping of the co-scheduled CCs.

11. The method of claim 1, wherein a sub-grouping of the co-scheduled CCs is a bandwidth part (BWP)-level sub-grouping, wherein each BWP configuration for a given cell is associated with a sub-group, and wherein a BWP switching on a certain CC changes the sub-grouping of the co-scheduled CCs.

12. The method of claim 1, wherein:
the MC-DCI includes a radio resource control (RRC) parameter that indicates for which sub-groups of co-scheduled CCs an MCS index lookup table is used when the MC-DCI is with an MCS cell radio network temporary identifier (MCS-C-RNTI); or
the MC-DCI includes an RRC parameter for each CC of the co-scheduled CCs that indicates for which CCs the MCS index lookup table is used when the MC-DCI is with the MCS-C-RNTI.

13. The method of claim 1, wherein:
the antenna port(s) field indicates a value of antenna port(s) for two codewords and a value of an MCS index for CCs of the co-scheduled CCs in which both codewords are not disabled; or
the antenna port(s) field indicates a value of antenna port(s) for one codeword for CCs of the co-scheduled CCs in which a codeword is disabled.

14. The method of claim 1, wherein an MCS for CCs in which a codeword is disabled and a value of antenna port(s) for CCs in which the codeword is disabled are configured via radio resource control signaling for each value of the antenna port(s) field.

15. A method of wireless communication performed by a network node, comprising:
transmitting, to a user equipment (UE), a multi-cell downlink control information (MC-DCI) that indicates scheduling information for co-scheduled component carriers (CCs), wherein the MC-DCI indicates one or more of an antenna port(s) field or a modulation and coding scheme (MCS) field to be commonly applied to one or more of the co-scheduled CCs; and
performing a transmission based at least in part on the scheduling information indicated by the MC-DCI.

16. An apparatus for wireless communication at a user equipment (UE), comprising:
a memory; and
one or more processors, coupled to the memory, configured to:
receive, from a network node, a multi-cell downlink control information (MC-DCI) that indicates scheduling information for co-scheduled component carriers (CCs), wherein the MC-DCI indicates one or more of an antenna port(s) field or a modulation and coding scheme (MCS) field to be commonly applied to one or more of the co-scheduled CCs; and
perform a transmission based at least in part on the scheduling information indicated by the MC-DCI.

17. The apparatus of claim 16, wherein the co-scheduled CCs are associated with one or more of: a same number of codewords, a same demodulation reference signal type, a same maximum length, and a same number of transmission configuration indication (TCI) states per TCI codepoint, and wherein the antenna port(s) field for the co-scheduled CCs is a common lookup table for the co-scheduled CCs.

18. The apparatus of claim 16, wherein:
an MCS table downlink control information (DCI) radio resource control (RRC) parameter is set to quadrature amplitude modulation (QAM) 1024, QAM 256, or QAM 64 low spectral efficiency for the co-scheduled CCs; or
the MCS table DCI RRC parameter is not configured for any of the co-scheduled CCs.

19. The apparatus of claim 16, wherein an MCS table downlink control information (DCI) radio resource control (RRC) parameter is defined as a per-CC parameter, and a same MCS table DCI RRC parameter is associated with each of the co-scheduled CCs.

20. The apparatus of claim 16, wherein the MC-DCI indicates one or more of the antenna port(s) field or the MCS field for a first sub-group and a second sub-group, wherein the first sub-group is associated with a first subset of CCs of the co-scheduled CCs and the second sub-group is associated with a second subset of CCs of the co-scheduled CCs.

21. The apparatus of claim 16, wherein the MC-DCI indicates a common indication field that applies to a subset of co-scheduled CCs, of the co-scheduled CCs, associated with a sub-group, and wherein different bits in the MC-DCI are used for subsets of co-scheduled CCs in different sub-groups.

22. The apparatus of claim 16, wherein a subset of co-scheduled CCs, of the co-scheduled CCs, in a sub-group are associated with same radio resource control parameters.

23. The apparatus of claim 16, wherein a sub-grouping of the co-scheduled CCs is based at least in part on dedicated radio resource control (RRC) parameters, and wherein the UE is configured with an association between each of the co-scheduled CCs and each sub-group using the dedicated RRC parameters.

24. The apparatus of claim 16, wherein a sub-grouping of the co-scheduled CCs is based at least in part on whether the co-scheduled CCs are associated with a same antenna port(s) field or MCS field.

25. The apparatus of claim 16, wherein a sub-grouping of the co-scheduled CCs is a cell-level sub-grouping, wherein a plurality of bandwidth part configurations for a given cell are associated with a sub-group, and wherein a BWP is switchable on each CC without changing the sub-grouping of the co-scheduled CCs.

26. The apparatus of claim 16, wherein a sub-grouping of the co-scheduled CCs is a bandwidth part (BWP)-level sub-grouping, wherein each BWP configuration for a given cell is associated with a sub-group, and wherein a BWP switching on a certain CC changes the sub-grouping of the co-scheduled CCs.

27. The apparatus of claim 16, wherein:
the MC-DCI includes a radio resource control (RRC) parameter that indicates for which sub-groups of co-scheduled CCs an MCS index lookup table is used when the MC-DCI is with an MCS cell radio network temporary identifier (MCS-C-RNTI); or
the MC-DCI includes an RRC parameter for each CC of the co-scheduled CCs that indicates for which CCs the MCS index lookup table is used when the MC-DCI is with the MCS-C-RNTI.

28. The apparatus of claim 16, wherein:
the antenna port(s) field indicates a value of antenna port(s) for two codewords and a value of an MCS index for CCs of the co-scheduled CCs in which both codewords are not disabled; or
the antenna port(s) field indicates a value of antenna port(s) for one codeword for CCs of the co-scheduled CCs in which a codeword is disabled.

29. The apparatus of claim 16, wherein an MCS for CCs in which a codeword is disabled and a value of antenna port(s) for CCs in which the codeword is disabled are configured via radio resource control signaling for each value of the antenna port(s) field.

30. An apparatus for wireless communication at a network node, comprising:
a memory; and
one or more processors, coupled to the memory, configured to:
transmit, to a user equipment (UE), a multi-cell downlink control information (MC-DCI) that indicates scheduling information for co-scheduled component carriers (CCs), wherein the MC-DCI indicates one or more of an antenna port(s) field or a modulation and coding scheme (MCS) field to be commonly applied to one or more of the co-scheduled CCs; and
perform a transmission based at least in part on the scheduling information indicated by the MC-DCI.
